(19) United States
(12) Patent Application Publication
(10) Pub. No.: US 2010/0310306 A1
(43) Pub. Date: Dec. 9, 2010

(54) IMPROVED INTERNAL LOCKING DEVICE FOR EXTENDABLE TELESCOPIC POLES

(76) Inventor: Wright Peter Wright, Isle of Capri, Gold Coast (AU)

Correspondence Address: Walter Peter Wright, 103 Gibraltar Drive, Isle of Capri, Gold Coast, 4217, omitted

(21) Appl. No.: 12/680,558

(22) PCT Filed: Sep. 25, 2008
(86) PCT No.: PCT/AU2008/001428

§ 371 Date: Mar. 26, 2010

(30) Foreign Application Priority Data
Sep. 28, 2007 (AU) 2007905325

(51) Int. Cl. F16B 7/10

(52) U.S. Cl. 403/109.1; 403/202

(57) ABSTRACT

An internal locking device (11) for a telescopic extendable pole (10) of the type comprising an inner and outer telescopic section (13,12) and a stop (22) on the outer section (13) which prevents detachment of the inner section (13) from the outer section (12). The locking device (11) has a mechanical locking means (18) which can be actuated to lock the two sections (12,13) together and a rotatable collar (24) is provided adjacent the locking means (28) to prevent contact between the stop (22) and the locking means (28).

### TECHNICAL FIELD

This invention relates to an improved internal locking device for telescoping extendable poles. The present invention also relates to a telescopic pole including an improved internal locking device.

### BACKGROUND ART

Tubular telescopic poles comprising a plurality of telescoping sections which are slidably received one inside the other for permitting the length of the pole to be adjusted are known. In poles of this type, locking devices for selectively restricting the relative sliding movement between the respective telescoping sections are known, the locking devices usually being mounted on the internal pole section and being arranged to selectively restrict relative sliding movement between the respective telescoping sections of the pole when one pole section is rotated relative to the other pole section.

The locking devices are generally a fragile mechanical apparatus that forces a surface area such as a cam or a nut into contact with the inner surface of the wall of the outer telescopic section of the extendable pole. This action causes the surface area to engage the slideable sections in a held selected position in the same manner as a brake until the cam or nut is disengaged and no longer contacts the inner wall surface of the outer telescopic section. The mechanical locking apparatus can include a cam operating mechanism or a screw and nut operating mechanism.

To prevent the disengagement between the inner and outer tubular sections, the outer section is provided with a stop which is generally formed by punching, crimping or knurling an indent into the outside tube or by a sleeve positioned between the outside and inner sections

During operation, impact of the fragile mechanical locking apparatus against the stop can cause irreversible damage. Further as the mechanical apparatus is located within the telescoping sections of the pole, access is not available for repair of the damaged parts. Impact of the mechanical locking apparatus against the stop can also cause jamming which results in the restriction of any further movement of the sliding sections of the pole.

Failure of the locking device can also result from sand or grit entering the mechanical apparatus causing seizure. The seizure cannot be corrected because the mechanism is internal and cannot be accessed to remove the sand or grit

Failure of the locking device can result in damage to property, serious injury and possible fatality, if the failure occurs when the telescopic pole is required during hazardous conditions such as boat mooring in adverse weather.

### SUMMARY OF THE INVENTION

The present invention aims to provide an improved locking device for telescopic extendable poles which overcomes or alleviates the above disadvantages or at least provides an alternative to the known telescopic pole locking devices. The present invention also aims to provide a telescopic extendable pole provided with an improved locking device. Other objects and advantages of the invention will become apparent from the following description.

The present invention thus provides in one preferred aspect, an internal locking device for a telescopic extendable pole of the type comprising an inner and outer telescopic section and first stop means on said outer section adapted to prevent detachment of said inner section, said locking device being located on said inner section and including locking means adapted to cooperate with said outer section to lock said sections against movement and characterized by second stop means movable longitudinally with said inner section and located between said locking means and said first stop means and adapted to prevent contact between said first stop means and said locking means.

The second stop means acts as a shock absorber shielding the locking means from striking the first stop means thus preventing damage to the locking means which is usually a fragile mechanical locking apparatus.

Preferably the second stop means comprises an annular collar. Preferably the collar substantially occupies the annular space between the inner and outer tubular telescopic sections.

Preferably the collar is mounted for free rotation relative to the inner section about an axis extending longitudinally of the inner section.

Preferably the collar is located adjacent to the locking means. The locking means may typically comprise an inner member fixed to the inner tubular section and the collar may be mounted on a body of the inner member. The body of the inner member may be provided with an annular channel to rotatably receive the collar. The annular channel may be bounded by opposite shoulders whereby the collar may be captured therebetween.

The collar in addition to acting as a shock absorber will also prevent unintentional jamming of the sliding telescopic sections. The collar also prevents sand and or grit from entering the locking device thus preventing seizure and failure of the locking means. The only point for entry of sand or grit into the interior of the telescoping pole is through the opening where the interior telescopic sliding section extends or retracts from the exterior section. The impact resistant collar is located between the opening and the locking means and because the outside diameter of the impact resistant collar is substantially the same as the inside diameter of the external section, any sand or grit will be prevented from bypassing the impact resistant collar and entering the mechanical components of the locking means.

The present invention in a further preferred aspect provides a telescopic extendable pole of the type comprising an inner and outer telescopic sections and first stop means on said outer section adapted to prevent detachment of said inner section and a locking device located on said inner section and having locking means adapted to cooperate with said outer section to lock said sections against movement and characterized by second stop means mounted for movement longitudinally with said inner section and located between said locking means and said first stop means and adapted to prevent contact between said first stop means and said locking means.

Preferably the second stop means comprises an annular collar which substantially occupies the space between said inner and outer sections. Suitably the collar is mounted for rotation about an axis extending substantially longitudinally of the pole and coaxially of the collar.

### BRIEF DESCRIPTION OF THE DRAWINGS

In order that the invention may be more readily understood and put into practical effect, reference is made to the accompanying drawings which illustrate a preferred embodiment of the invention and wherein:

FIG. 1 illustrates a common telescopic pole provided with an improved locking device according to an embodiment of the present invention;

FIG. 2 is an isometric enlarged cut-away view of the region A of FIG. 1 showing the improved internal locking device;

FIG. 3 is an enlarged longitudinal sectional view of the telescopic pole showing the improved locking device and further showing the stop on the outer tubular section and the impact resistant rotating collar on the inner tubular section;

FIG. 4 illustrates in side view the end of the inner tubular section projecting from the outer or external section and carrying the locking device; and

FIG. 5 is a cross sectional view along line B-B of FIG. 4.

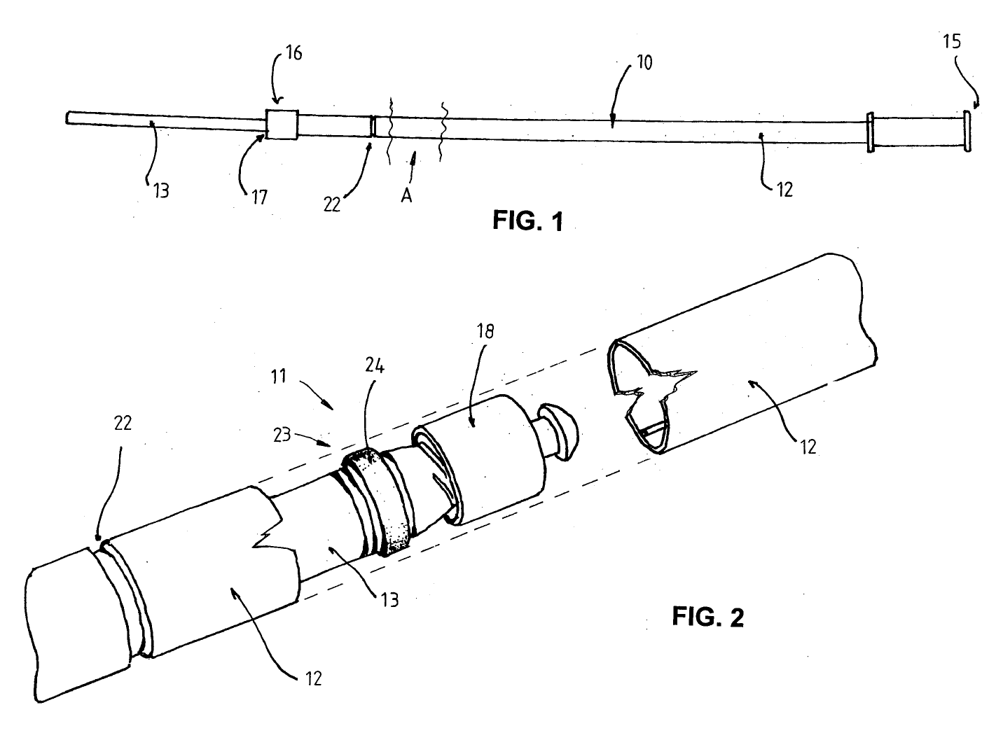

### DETAILED DESCRIPTION OF THE PREFERRED EMBODIMENT

Referring to the drawings, there is illustrated a telescopic pole 10 incorporating an improved locking device 11 according to the present invention, the telescopic pole 10 as is conventional having slidable elongated telescopic sections comprising a larger diameter external telescopic section 12 and a smaller diameter internal telescopic section 13 which is telescopically slidable relative to the outer or external section 12. The external section 12 is provided with a handle 15 at one end and a sleeve 16 at its other end surrounding the opening 17 in the end of the section 12 through which the inner sliding section 13 passes.

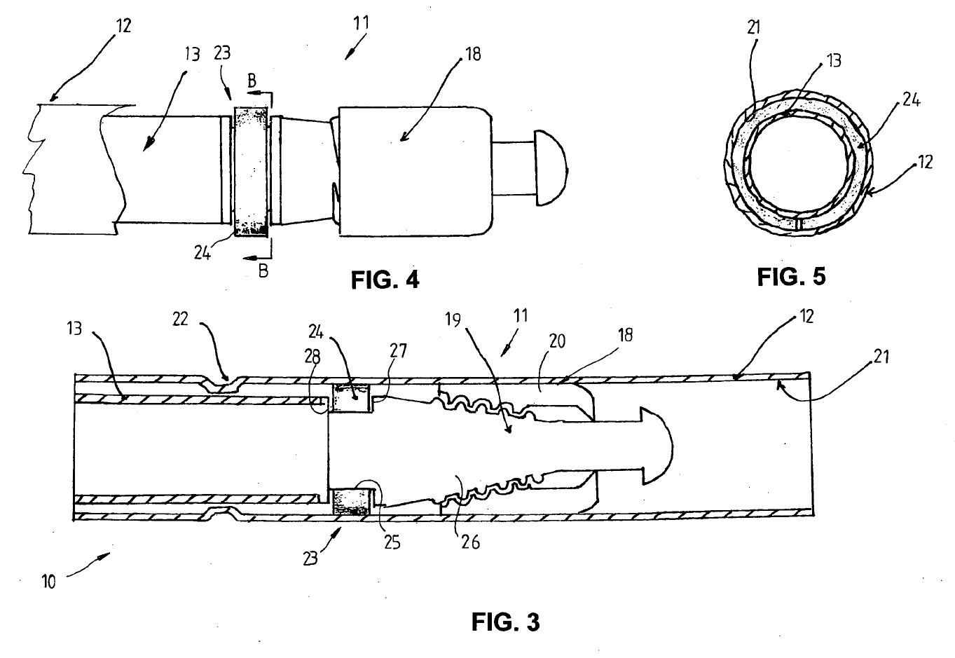

The inner end of the telescopic section 13 within the outer section 12 is provided with a known mechanical locking apparatus 18 which when rotated with the section 13 relative to the section 12 locks the section 13 is a desired extended position relative to the section 12. The mechanical locking apparatus 18 as shown in FIG. 3 includes a tapering male threaded member 19 fixed to the inner end of the inner section 13 which is threaded into a corresponding tapering thread of a split collar 20. Rotation of the threaded member 19 by rotation of the section 13 in one direction will cause radial expansion of the collar 20 and frictional engagement of the collar 20 with the inner wall 21 of the section 12. This therefore locks the section 13 to the section 12. The mechanical locking apparatus 18 described above is only one form of known locking apparatus which may be used with the present invention. Other forms of locking apparatus as known in the art may also be used.

To prevent detachment of the inner section 13 from the outer section 12, a stop 22 is located on the external section 12 between the sleeve 16 and the handle 15 in a preferred location that allows maximum travel of the internal sliding section 13, the stop 22 being in the path of movement of the locking apparatus 18. The stop 22 is of annular form and typically formed by crimping of the section 12.

To prevent direct contact between the mechanical locking apparatus 18 (which is relatively fragile) and the stop 22, the present invention provides an impact preventing device 23 which is located adjacent to the mechanical locking apparatus 18 and positioned between the stop 22 and the mechanical apparatus 18.

The impact preventing device 23 comprises in this embodiment an annular collar 24 which is located in an annular channel 25 formed in the body 26 of the male threaded member 19. The collar 24 is captured between opposing shoulders 27 and 28 defined by the channel 25 in the body 26 and by the end of the inner section 13 respectively with the body 26 extending into the end of the inner section 13 and being fixed thereto by rivets or crimping. Thus the collar 24 is positioned in the channel 25 prior to the connection of the body 26 to the inner pole section 13. Further the collar 24 has a width slightly less than the width of the channel 25 and an inner diameter slightly greater than the diameter of the channel 25 at its radially inner face such that the collar 24 is freely rotatable about an axis extending longitudinally of the sections 12 and 13 and coaxially of the collar.

As shown in FIG. 5, the collar 24 has an external diameter which is substantially the same as the internal diameter of the section 12. The collar 24 being rotatable relative to the member 13 will thus allow free rotation of the tubular section 13 relative to the tubular section 12 so as not to interfere with the locking action of the mechanical locking apparatus 18. The collar 24 however substantially occupies the annular space between the inner section 13 and the outer section 12 which will prevent sand, grit of any other materials bypassing to the mechanical apparatus 18 through the opening 17.

Where the inner section 13 is moved outwardly of the outer section 12, the impact resistant collar 24 between the stop 22 and the mechanical apparatus 18 acts as a buffer for the protection of the mechanical apparatus 18. Thus the collar 24 will absorb the impact of the stop 22 to thereby protect the fragile mechanical apparatus 18 from damage caused by impact with the stop 22

In addition, as the collar 24 is rotatable it will prevent jamming of the of the slideable telescopic sections 12 and 13 of the telescopic pole 10 and further prevent sand or grit entering the mechanical apparatus 18.

The telescopic pole 10 with the locking device 11 of the invention may be used in many different applications. A typical application however is as a pole for boat hooks. The telescopic sections 12 and 13 of the pole 10 are typically formed as aluminium extrusions however they may be formed of other materials

Whilst the rotatable collar 24 is described to be mounted on the male body of the mechanical locking apparatus 18, it may alternatively be mounted on a purpose constructed mounting body fixed to the inner pole section 12 or mounted directly on the pole section 12. The collar 24 typically if formed of plastics but may be formed of metal. The collar 24 may also be split longitudinally relative to the pole 10 to allow it to be passed longitudinally over the locking apparatus 18 for location in the channel 25. The channel 25 may also be fully formed within the body 26. Furthermore, the outer surface of the collar 24 may be provided with one or more grooves extending parallel to the central axis of the collar so as to allow air to pass from one side of the collar 24 to the other side of the collar 24 when the sections 12 and 13 are moved relative to each other.

The term “comprising” or derivatives thereof as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

1. An internal locking device for a telescopic extendable pole of the type comprising an inner and outer telescopic section and first stop means on said outer section adapted to prevent detachment of said inner section, said locking device being located on said inner section and including locking means adapted to cooperate with said outer section to lock said sections against movement and characterized by second stop means movable longitudinally with said inner section and located between said locking means and said first stop means and adapted to prevent contact between said first stop means and said locking means.

2. A locking device as claimed in claim 1 wherein said second stop means comprises an annular collar.

3. A locking device as claimed in claim 2 wherein said collar substantially occupies the annular space between the inner and outer tubular telescopic sections.

4. A locking device as claimed in claim 3 wherein said collar is mounted for free rotation relative to the inner section about an axis extending longitudinally of the inner section.

5. A locking device as claimed in claim wherein said locking means includes an inner member fixed to the inner tubular section and wherein said collar is mounted on a body of the inner member.

6. A locking device as claimed in claim 5 wherein said body is provided with an annular channel to rotatably receive the collar.

7. A locking device as claimed in claim 6 wherein said annular channel is bounded by opposite shoulders to capture said collar therebetween.

8. A telescopic extendable pole of the type comprising an inner and outer telescopic sections and first stop means on said outer section adapted to prevent detachment of said inner section and a locking device located on said inner section and having locking means adapted to cooperate with said outer section to lock said sections against movement and characterized by second stop means movable longitudinally with said inner section and located between said locking means and said first stop means and adapted to prevent contact between said first stop means and said locking means.

9. A telescopic extendable pole as claimed in claim 8 wherein said second stop means comprises an annular collar which substantially occupies the space between said inner and outer sections.

10. A telescopic extendable pole as claimed in claim 9 wherein said collar is mounted for rotation about an axis extending substantially longitudinally of said pole and coaxially of said collar.
